(19) United States
(12) Patent Application Publication
(10) Pub. No.: US 2006/0024462 A1
(43) Pub. Date: Feb. 2, 2006

(54) Multi-ply multi-indicia marker pad

(76) Inventors: Tsung-Tien Kuo, Kaohsiung Hsien (TW); Jen-Rong Liu, Feng-Shan City (TW); Chin-Chung Tsai, Pan-Chiao City (TW)

Correspondence Address: FROMMER LAWRENCE & HAUG, 745 FIFTH AVENUE- 10TH FL., NEW YORK, NY, 10151, US

(21) Appl. No.: 10/900,686

(22) Filed: Jul. 27, 2004

(51) Int. Cl. B32B 33/00

(52) U.S. Cl. 428/40.1; 428/43

(57) ABSTRACT

A multi-ply multi-indicia marker pad includes a plurality of marker elements stacked one above the other to form a stack, and a bottom panel. Each of the marker elements has a side edge, a bottom surface that is coated with a repositionable adhesive layer, and at least one cutting line that separates the marker element into a plurality of discrete markers respectively having distinct signs printed thereon. The repositionable adhesive layer crosses the cutting line. The bottom panel is disposed underneath and is connected adhesively to a lowermost one of the marker elements in the stack.

### BACKGROUND OF THE INVENTION

1. Field of the Invention

This invention relates to a multi-ply multi-indicia marker pad, more particularly to a multi-ply multi-indicia marker pad having a plurality of marker elements, each of which is formed with at least a cutting line that separates the marker element into discrete markers having distinct sings printed thereon.

2. Description of the Related Art

Marker pads are used for marking on a place, such as an underlined area on a document for signature, or one page of a magazine for reference, etc., so as to facilitate the user or the reader. Currently, commercially available marker pads include signs, such as a warning sign, a question mark, or a signature sign, etc. Each conventional marker pad includes a plurality of stacked markers having the same sign printed thereon and the same shape. As such, the user is compelled to buy different marker pads for different signs, which results in inconvenience in storing the marker pads.

### SUMMARY OF THE INVENTION

Therefore, the object of the present invention is to provide a multi-ply multi-indicia marker pad that is capable of overcoming the aforementioned drawback of the prior art.

According to one aspect of the present invention, there is provided a multi-ply multi-indicia marker pad that comprises: a plurality of marker elements stacked one above the other to form a stack, each of the marker elements having a bottom surface that is coated with a repositionable adhesive layer, and at least one cutting line that separates the marker element into a plurality of discrete markers respectively having distinct signs printed thereon for marking under different situations, the repositionable adhesive layer crossing the cutting line so as to be bonded to the discrete markers; and a bottom panel disposed underneath and connected adhesively to a lowermost one of the marker elements in the stack.

According to another aspect of this invention, there is provided a multi-ply multi-indicia marker pad that comprises: a plurality of marker elements stacked one above the other to form a stack, each of the marker elements having a bottom surface that is coated with a plurality of spaced apart repositionable adhesive layers, and a plurality of cutting lines that separate the marker element into a plurality of discrete markers which respectively have distinct signs printed thereon, at least one of the repositionable adhesive layers crossing a respective one of the cutting lines so as to be bonded to two adjacent ones of the discrete markers, the remainder of the repositionable adhesive layers being respectively provided on the remainder of the discrete markers; and a bottom panel disposed underneath and connected adhesively to a lowermost one of said marker elements in said stack.

### BRIEF DESCRIPTION OF THE DRAWINGS

In drawings which illustrate embodiments of the invention,

FIG. 1 is a perspective view of the first preferred embodiment of a multi-ply multi-indicia marker pad according to this invention;

FIG. 2 is a top view of a marker element of the multi-ply multi-indicia marker pad of the first embodiment;

FIG. 3 is a side view of the marker element of FIG. 2;

FIG. 4 is a perspective view of the second preferred embodiment of the multi-ply multi-indicia marker pad according to this invention;

FIGS. 5 and 6 are schematic views to illustrate how the multi-ply multi-indicia marker pad of the second embodiment is used;

FIG. 7 is perspective view of the third preferred embodiment of the multi-ply multi-indicia marker pad according to this invention; and

FIG. 8 is a perspective view of the fourth preferred embodiment of the multi-ply multi-indicia marker pad according to this invention.

### DETAILED DESCRIPTION OF THE PREFERRED EMBODIMENTS

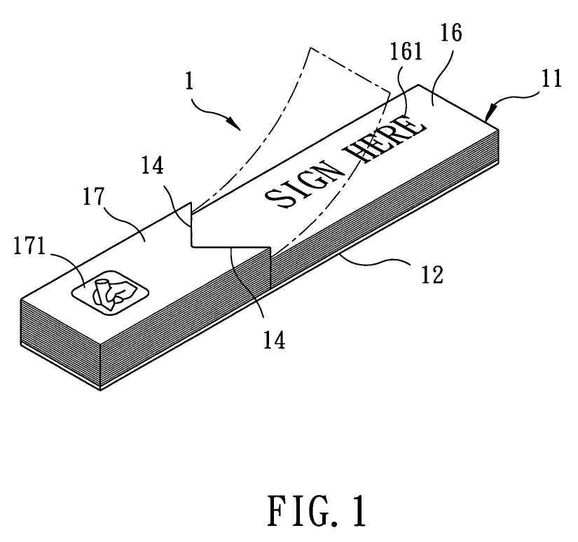

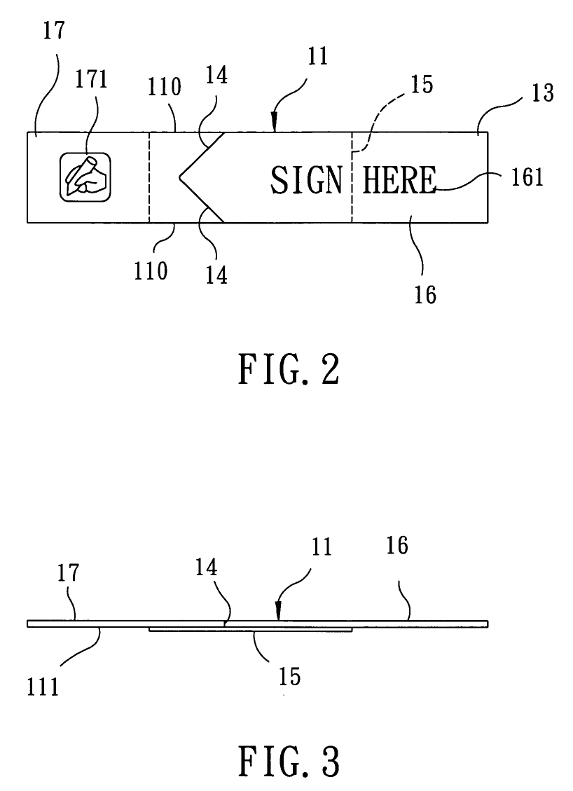

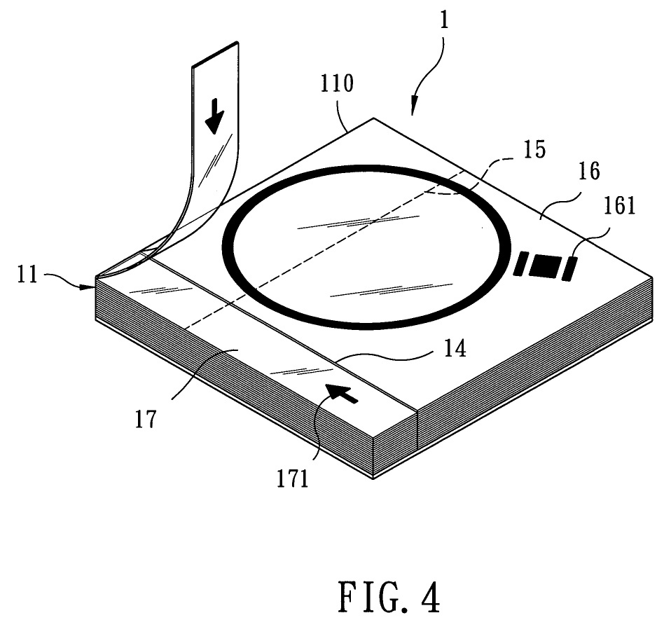

FIGS. 1 to 3 illustrate the first preferred embodiment of a multi-ply multi-indicia marker pad 1 according to this invention. The marker pad 1 includes: a plurality of marker elements 11 stacked one above the other to form a stack, each of the marker elements 11 having two opposite side edges, a bottom surface 111 that is coated with a repositionable adhesive layer 15, and at least one cutting line 14 (there are two cutting lines 14 formed in each marker element 11 in this embodiment) that separates the marker element 11 into discrete markers, which are referred to as primary and auxiliary markers 16, 17 in this embodiment, respectively having distinct signs 161, 171, printed thereon for marking under different situations, the repositionable adhesive layer 15 extending to at least one of the side edges 110, crossing the two cutting lines 14 so as to be bonded to the primary and auxiliary markers 16, 17, and being made from pressure sensitive adhesive, the two cutting lines 14 of this embodiment intersecting each other to form a pointed tip at one end of the primary marker 16; and a bottom panel 12 disposed underneath and connected adhesively to a lowermost one of the marker elements 11 in the stack. Each of the marker elements 11 can be made from paper or a plastic material. Preferably, each of the marker elements 11 is translucent and colored. In this embodiment, the primary marker 16 can serve as a pointer that identifies the area of a document (not shown) to be signed, whereas the auxiliary marker 17 can serve as a tag for marking the location of the primary marker 16 when the latter is attached to the document.

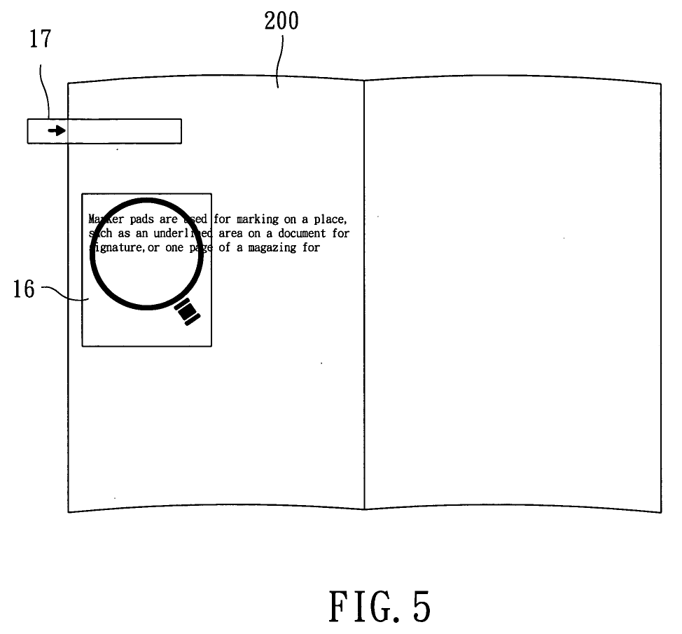

FIG. 4 illustrates the second preferred embodiment of the multi-ply multi-indicia marker pad 1 of this invention that is similar to the previous embodiment, except that only one straight cutting line 14 is formed and that the signs 161, 171 respectively printed on the primary and auxiliary markers 16, 17 differ from those of the previous embodiment.

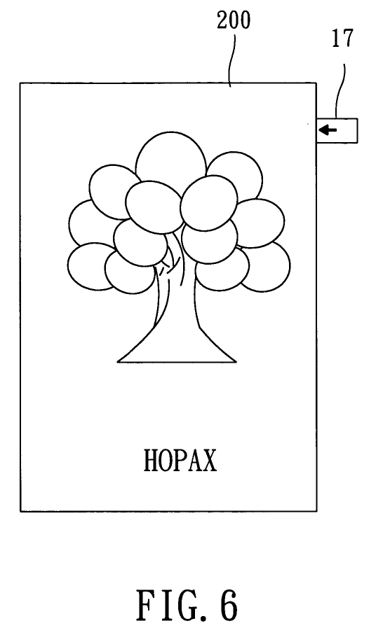

FIGS. 5 and 6 illustrate how the multi-ply multi-indicia marker pad 1 of the second preferred embodiment is used for highlighting an important passage on a page of a book 200. In the case of transparent plastic material from which the marker elements 11 are made, the primary marker 16 can serve as a highlighting pointer for highlighting the important passage on the page of the book 200, whereas the auxiliary marker 17 can serve as a tag for marking the desired page of the book 200 where the primary marker 16 is located. In the case of paper from which the marker elements 11 are made, the primary marker 16 can serve as a memo for writing down comments directed to an important passage on a page of a book, whereas the auxiliary marker 17 can serve as a tag for marking the desired page of the book where the primary marker 16 is located.

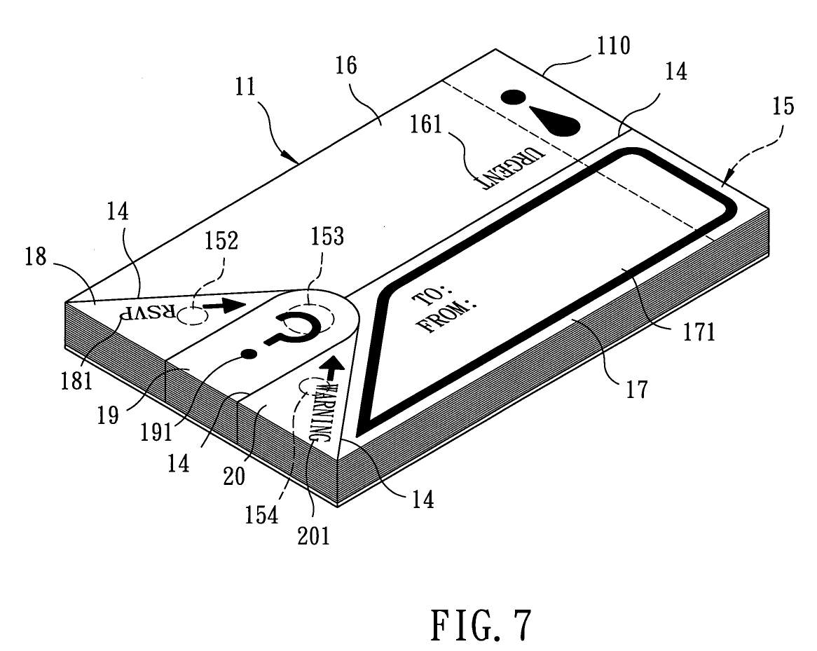

FIG. 7 illustrates the third preferred embodiment of the multi-ply multi-indicia marker pad 1 of this invention that is similar to the first embodiment, except that four cutting lines 14 are formed on each marker element 11 and are interconnected so that each marker element 11 can be separated into five markers 16, 17, 18, 19, 20 which are printed with distinct signs 161, 171, 181, 191, 201. The repositionable adhesive layer 15 extends to the side edge 110 of the respective marker element 11, and crosses a respective one of the cutting lines 14 so as to be bonded to two adjacent ones of the markers 16, 17, 18, 19, 20. Three additional repositionable adhesive layers 152, 153, 154 are respectively provided on the markers 18, 19, 20.

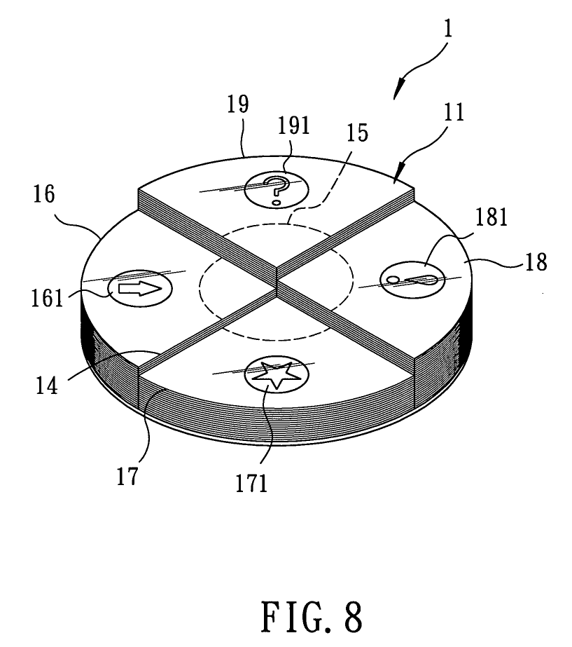

FIG. 8 illustrates the fourth preferred embodiment of the multi-ply multi-indicia marker pad 1 of this invention that is similar to the first embodiment, except that the multi-ply multi-indicia marker pad 1 of this embodiment is circular in shape, that the cutting lines 14 cross each other to separate each marker element 11 into four sector-shaped markers 16, 17, 18, 19, and that the repositionable adhesive layer 15 is circular in shape and extends radially from a center of each marker element 11.

With the inclusion of the cutting lines 14 and the repositionable adhesive layer 15 extending along at least one side edge 110 of each marker element 11, the different markers 16, 17, 18, 19, 20 can be grouped together and firmly attached to the bottom panel 12 without being easily detached and can be peeled off therefrom with relative ease. The multi-ply multi-indicia marker pad 1 of this invention is much easier to store as compared to the conventional marker pads. Moreover, by pairing the primary and auxiliary markers 16, 17 on each marker element 11, the usage of the multi-ply multi-indicia marker pad 1 can be broadened. In addition, with the inclusion of the repositionable adhesive layer 15 in the multi-ply multi-indicia marker pad 1, the markers 16, 17, 18, 19, 20 can be repositioned.

With the invention thus explained, it is apparent that various modifications and variations can be made without departing from the spirit of the present invention. It is therefore intended that the invention be limited only as recited in the appended claims.

We claim:

1. A multi-ply multi-indicia marker pad comprising:
a plurality of marker elements stacked one above the other to form a stack, each of said marker elements having a side edge, a bottom surface that is coated with a repositionable adhesive layer, and at least one cutting line that separates said marker element into a plurality of discrete markers respectively having distinct signs printed thereon for marking under different situations, said repositionable adhesive layer crossing said cutting line so as to be bonded to said discrete markers; and
a bottom panel disposed underneath and connected adhesively to a lowermost one of said marker elements in said stack.

2. The multi-ply multi-indicia marker pad of claim 1, wherein each of said marker elements is made from paper.

3. The multi-ply multi-indicia marker pad of claim 1, wherein each of said marker elements is made from a plastic material.

4. The multi-ply multi-indicia marker pad of claim 1, wherein said repositionable adhesive layer is made from pressure sensitive adhesive.

5. The multi-ply multi-indicia marker pad of claim 1, wherein said markers of each of said marker elements include a primary marker that serves as a memo sheet for notification, and an auxiliary marker that serves as a tag for marking location of said primary marker when said primary marker is attached to a document.

6. The multi-ply multi-indicia marker pad of claim 1, wherein said markers of each of said marker elements include a primary marker that is transparent and that serves as a highlighting pointer for notification, and an auxiliary marker that serves as a tag for marking location of said primary marker when said primary marker is attached to a document.

7. A multi-ply multi-indicia marker pad comprising:
a plurality of marker elements stacked one above the other to form a stack, each of said marker elements having a bottom surface that is coated with a plurality of spaced apart repositionable adhesive layers, and a plurality of cutting lines that separate said marker element into a plurality of discrete markers which respectively have distinct signs printed thereon, at least one of said repositionable adhesive layers crossing a respective one of said cutting lines so as to be bonded to two adjacent ones of said discrete markers, the remainder of said repositionable adhesive layers being respectively provided on the remainder of said discrete markers; and
a bottom panel disposed underneath and connected adhesively to a lowermost one of said marker elements in said stack.
